(19) United States
(12) Patent Application Publication
(10) Pub. No.: US 2010/0199226 A1
(43) Pub. Date: Aug. 5, 2010

(54) Method and Apparatus for Determining Input Information from a Continuous Stroke Input

(75) Inventor: Mikko Nurmi, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/363,135

(22) Filed: Jan. 30, 2009

(51) Int. Cl. G06F 3/033; G09G 5/00

(52) U.S. Cl. 715/863; 345/173

(57) ABSTRACT

An apparatus, comprising a processor configured to receive a continuous stroke input related to a virtual keypad, determine a first input information based at least in part on said continuous stroke input, display a shape associated with said first input information, receive input associated with said shape, and determine a second input information based at least in part on said shape and said input associated with said shape is disclosed.

### RELATED APPLICATIONS

This application also relates to U.S. Patent Application, entitled “METHOD AND APPARATUS FOR DETERMINING INPUT INFORMATION COMPRISING CONTROL FROM A CONTINUOUS STROKE INPUT”, which is being filed concurrently and is hereby incorporated by reference in its entirety.

### TECHNICAL FIELD

The present application relates generally to touch display input.

### BACKGROUND

There has been a recent surge in the use of touch displays on electronic devices. Some of these electronic devices rely on a virtual keypad for receiving input from a user. The user may input information into the electronic device by using the virtual keypad that comprises one or more virtual keys that relate to a character, control, and/or the like.

### SUMMARY

Various aspects of examples of the invention are set out in the claims.

According to a first aspect of the present invention, an apparatus, comprising a processor configured to receive a continuous stroke input related to a virtual keypad, determine a first input information based at least in part on said continuous stroke input, display a shape associated with said first input information, receive input associated with said shape, and determine a second input information based at least in part on said shape and said input associated with said shape is disclosed.

According to a second aspect of the present invention, a method, comprising receiving a continuous stroke input related to a virtual keypad, determining a first input information based at least in part on said continuous stroke input, displaying a shape associated with said first input information, receiving input associated with said shape, and determining a second input information based at least in part on said shape and said input associated with said shape is disclosed.

According to a third aspect of the present invention, a computer program product, comprising code for receiving a continuous stroke input related to a virtual keypad, code for determining a first input information based at least in part on said continuous stroke input, code for displaying a shape associated with said first input information, code for receiving input associated with said shape, and code for determining a second input information based at least in part on said shape and said input associated with said shape is disclosed.

According to a fourth aspect of the present invention, a computer-readable medium encoded with instructions that, when executed by a computer, perform receiving a continuous stroke input related to a virtual keypad, determining a first input information based at least in part on said continuous stroke input, displaying a shape associated with said first input information, receiving input associated with said shape, and determining a second input information based at least in part on said shape and said input associated with said shape is disclosed.

### BRIEF DESCRIPTION OF THE DRAWINGS

For a more complete understanding of example embodiments of the present invention, reference is now made to the following descriptions taken in connection with the accompanying drawings in which:

FIG. 1 is a flow diagram showing a method for determining input information associated with a continuous stroke input according to an example embodiment of the invention;

FIGS. 2A-2B are diagrams illustrating continuous stroke input in relation to a virtual keypad according to an example embodiment of the invention;

FIG. 3 is a flow diagram showing another method for determining input information associated with a continuous stroke input according to an example embodiment of the invention;

FIGS. 4A-4E are diagrams illustrating input associated with a displayed shape according to an example embodiment of the invention;

FIG. 5 is a flow diagram showing yet another method for determining input information associated with a continuous stroke input according to an example embodiment of the invention;

FIG. 6 is a flow diagram showing still another method for determining input information associated with a continuous stroke input according to an example embodiment of the invention;

FIGS. 7A-7D are diagrams illustrating a visual representation of a virtual keypad according to an example embodiment of the invention;

FIGS. 8A-8C are diagrams illustrating display position of a virtual keypad according to an example embodiment of the invention;

FIGS. 9A-9D are diagrams illustrating input from a touch display according to an example embodiment of the invention; and

FIG. 10 is a block diagram showing an electronic device according to an example embodiment of the invention.

### DETAILED DESCRIPTION OF THE DRAWINGS

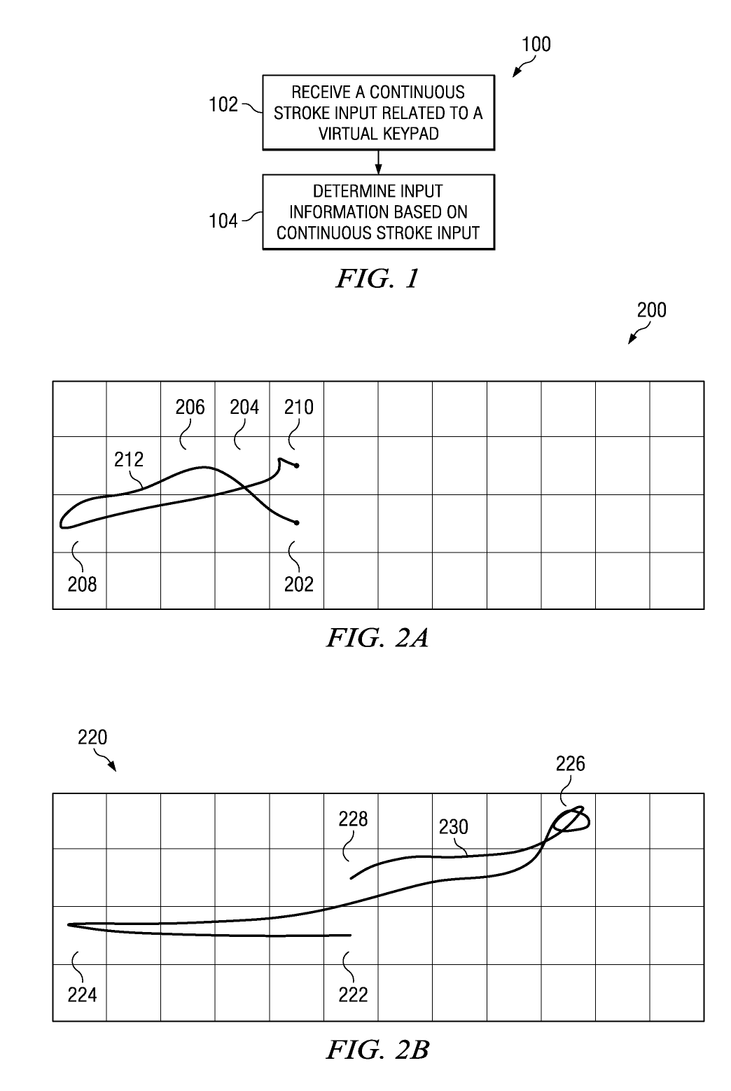

An example embodiment of the present invention and its potential advantages are understood by referring to FIGS. 1 through 10 of the drawings.

An apparatus may allow a user to input information using a virtual keypad by utilizing a continuous stroke input. In an example embodiment, a user may input a word by contacting a touch display on a virtual key. In such an example, the user may draw a shape on the virtual keypad that relates to the characters the user desires to place in a word. In this example, when the user removes contact from the touch display, a word associated with the characters on the virtual keypad that the shape intersects may form a word. For example, a user may contact the display on a virtual key for a “T” character, drag to a virtual key for an “H” character, drag to a virtual key for an “E” character, and then indicate termination of the continuous stroke input by removing contact from the touch display, dragging to a virtual key associated with termination, and/or the like. In such an example, the apparatus may determine that the user desired to input the word “THE” and utilize input information representing “THE”.

In an example embodiment, when an apparatus determines input information from a continuous stroke input, the apparatus may utilize a dictionary that comprises one or more words that the apparatus may evaluate. In addition, the apparatus may evaluate position, time, speed, and/or the like, associated with a continuous stroke input to determine input information. For example, the apparatus may interpret a speed change, a direction change, a termination, and/or the like, of the continuous stroke input as an indication of a user's intent to include the associated virtual key in the input information.

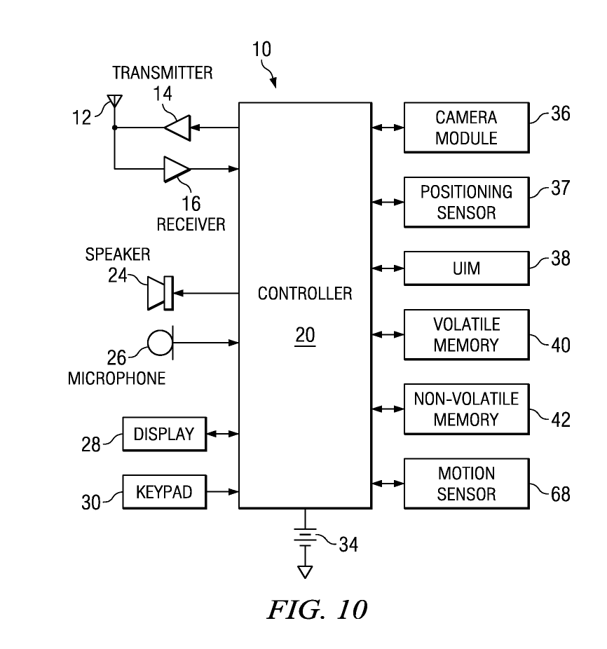

FIG. 1 is a flow diagram showing a method 100 for determining input information associated with a continuous stroke input according to an example embodiment of the invention. An apparatus, for example electronic device 10 of FIG. 10, may utilize method 100.

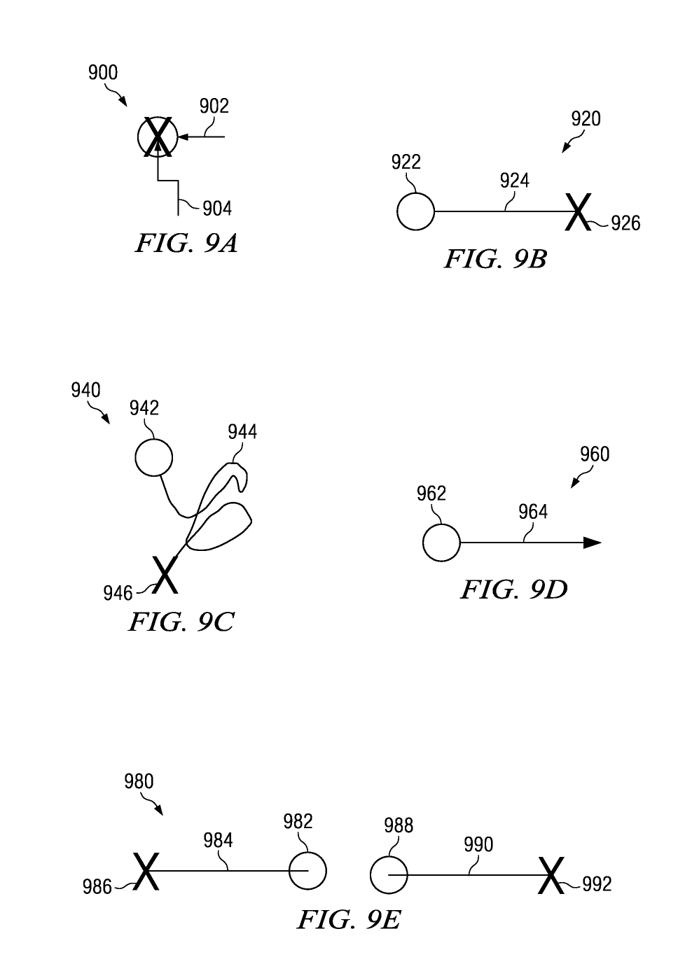

At block 102, the apparatus receives a continuous stroke input, for example, continuous stroke input 212 of FIG. 2A, related to a virtual keypad. The continuous stroke input may comprise position information, time information, speed information, and/or the like. A touch display, for example display 28, of FIG. 10, may receive the continuous stroke input. The apparatus may receive the continuous stroke input after the continuous stroke input terminates, before the continuous stroke input terminates, and/or the like. For example, the apparatus may receive continuous stroke input while a user is performing the continuous stroke input. In another example, the apparatus may receive continuous stroke input after the user has terminated a continuous stroke input. Termination of a continuous stroke input may relate to a release input, for example release input 946 of FIG. 9C, the continuous stroke intersecting with a region of the display associated with termination, the continuous stroke intersecting with a display boundary, and/or the like.

At block 104, the apparatus determines input information based, at least in part, on the continuous stroke input. In an example embodiment, input information comprises information associated with the relation of the continuous stroke input to virtual keys. The apparatus may utilize various methods for determining input information. For example, the apparatus may evaluate position information, time information, speed information, and/or the like associated with the continuous stroke input. In an example embodiment, the apparatus may interpret a change in continuous stroke input speed, a change in continuous stroke input direction, an increase in pressure, and/or the like, as an indicator that a virtual key should be associated with the input information. For example, if a continuous stroke input slows when intersecting a “W” character virtual key the input information may comprise a “W” character. In another example, if the continuous stroke input changes direction when intersecting a “d” character virtual key, the input information may comprise the “d” character.

The determination of block 104 may utilize a dictionary. The dictionary may comprise information associated with a word and/or set of characters, controls, and/or the like. The apparatus may utilize the dictionary to determine probable associations between the continuous input and one or more entries in the dictionary to determine at least one likely correlation between continuous stroke input and dictionary entry. For example, a continuous stroke input may indicate input information of “poke”, “pike”, “poker”, etc. In such an example, the apparatus may determine that input information of “pike” best relates to the continuous stroke input because the associated dictionary entry is the most likely correlation to the continuous stroke input.

In an example embodiment, the apparatus may perform the determination of block 104 during a continuous stroke input. For example, the apparatus may predict input information based on a non-terminated continuous stroke input. In such an example, the input information may comprise a character, a control, and/or the like, that relates to a virtual key to which the continuous stroke input does not yet relate. For example, if a non-terminated continuous stroke input indicates characters “polluti”, the apparatus may determine input information of “pollution” even though the continuous stroke input has not yet included the “on” characters. In such a circumstance, the apparatus may determine the input information, at least in part, to comprise the predicted input information of “on” characters.

FIGS. 2A-2B are diagrams illustrating continuous stroke input in relation to a virtual keypad according to an example embodiment of the invention. Although the examples of FIGS. 2A-2B show a virtual keypad, it should be understood that an apparatus may or may not display the virtual keypad. For example, an apparatus may provide an area where continuous stroke input may be received, but forego display of the virtual keypad. In such an example, a user may desire to avoid displaying the virtual keypad.

FIG. 2A is a diagram illustrating an example 200 of a continuous stroke input in relation to a virtual keypad. In an example embodiment, virtual key 202 relates to a “G” character, virtual key 204 relates to a “R” character, virtual key 206 relates to a “E” character, virtual key 208 relates to a “A” character, and virtual key 210 relates to a “T” character. In example 200, continuous stroke input 212 starts at virtual key 202, intersects with virtual keys 204, 206, 208, and terminates at virtual key 210. An apparatus may determine, for example utilizing method 100 of FIG. 1, input information of “GREAT” associated with continuous stroke input 212.

FIG. 2B is a diagram illustrating an example 220 of a continuous stroke input in relation to a virtual keypad. In an example embodiment, a circular part of a continuous stroke input over a virtual key indicates a double character. In an example embodiment, virtual key 222 relates to a “H” character, virtual key 224 relates to a “A” character, virtual key 226 relates to a “P” character, and virtual key 228 relates to a “Y” character. In example 220, continuous stroke input 230 starts at virtual key 222, intersect with virtual key 224, intersects and circles at virtual key 226, and terminates at virtual key 228. An apparatus utilizing method 100 of FIG. 1 may determine input information of “HAPPY” associated with continuous stroke input 230.

In an example embodiment, a user may desire guidance on input when inputting a large word. For example if a user is generating continuous stroke input for a very long word and the apparatus has determined, during the continuous stroke input, a high probable determination for the input information, the user may benefit from seeing a reference shape that may be traced to ensure the determination of the input information. For example, if a user is providing continuous stroke input to an apparatus with the intent to input the word “ENTOMOLOGY”, the apparatus may determine to a high probability that the continuous stroke input relates to the word “ENTOMOLOGY” after the user has only performed the continuous stroke input associated with “ENTOMO”. In such an example, the apparatus may display a shape corresponding to the word “ENTOMOLOGY”. The user may then trace the displayed shape to input the word “ENTOMOLOGY”. In a similar example, the user may select the displayed shape by dragging to a selection input, such as a virtual key related to a space, an icon denoting selection, and/or the like. Conversely, the displayed shape may not relate to the input information desired by the user. For example, if the user desires to input the word “ENTOMOLOGIST” and the shape relates to the word “ENTOMOLOGY”, the continuous stroke input may substantially differ from the shape. In such an example, the input information may be determined from the continuous stroke input.

In an example embodiment, the apparatus may display more than one shape. For example, if there is a high probability that the continuous stroke input relates to more than one word, the apparatus may show a shape for one or more of the words. In such an example, the shapes may differ by line pattern, color, display time, and/or the like. For example, the apparatus may display one shape as a solid line and another shape as a broken line, may display one shape as red and another as blue, may alternate between displaying one shape and another, and/or the like.

In an example embodiment, if the apparatus determines to a high probability that the continuous stroke input relates to one or more words, the apparatus may display the one or more words in a list. In such an example, the apparatus may allow a user to select from one or more of the words to determine input information.

In another example embodiment, a user may desire to modify input information from a previous continuous stroke input. For example, a user may select a word in a text editor to modify. In another example, a user may have a chance to modify input information before the input information is utilized, such as inserting the input information into a document. In such examples, a user may benefit from being able to modify the shape associated with the input information. For example, a user may be able to tap a shape, drag a part of the shape, and/or the like, to modify the virtual keys associated with the shape. In such an example, a user may be able to modify the shape of a long word more easily than performing a replacement continuous stroke input.

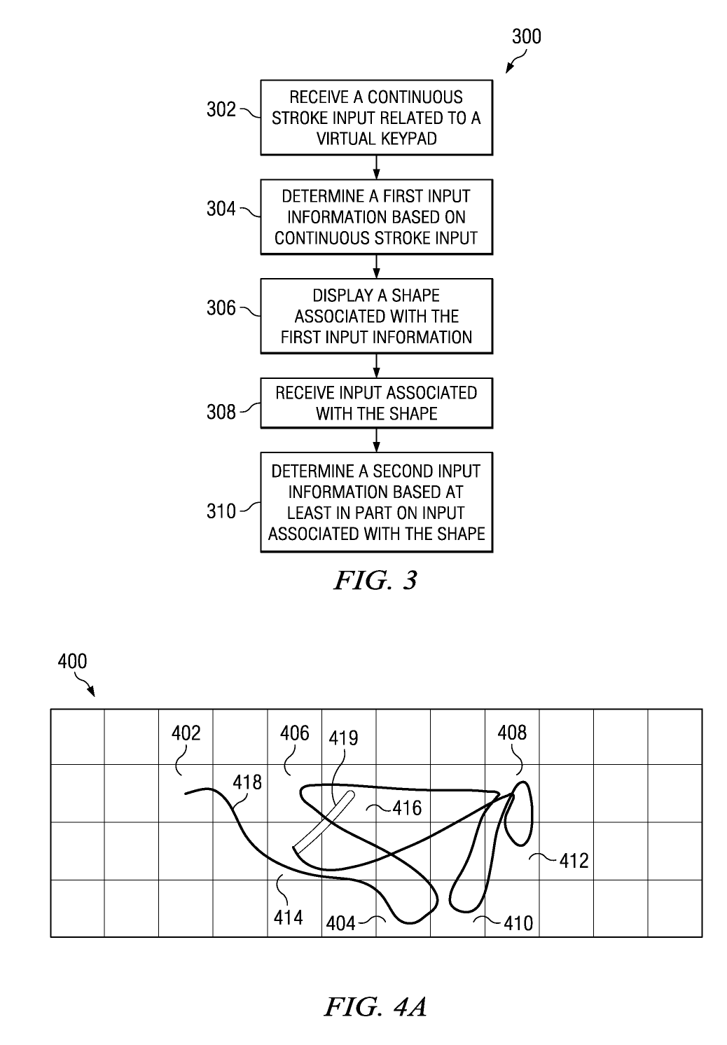

FIG. 3 is a flow diagram showing another method 300 for determining input information associated with a continuous stroke input according to an example embodiment of the invention. An apparatus, for example electronic device 10 of FIG. 10, may utilize method 300.

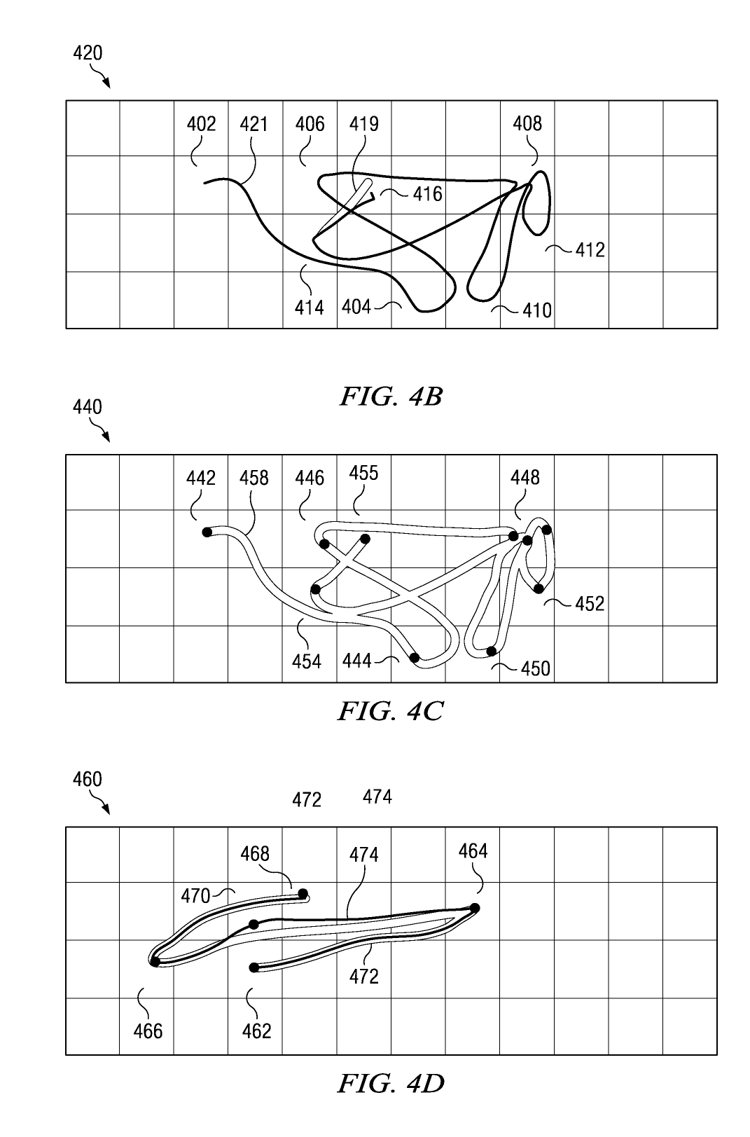

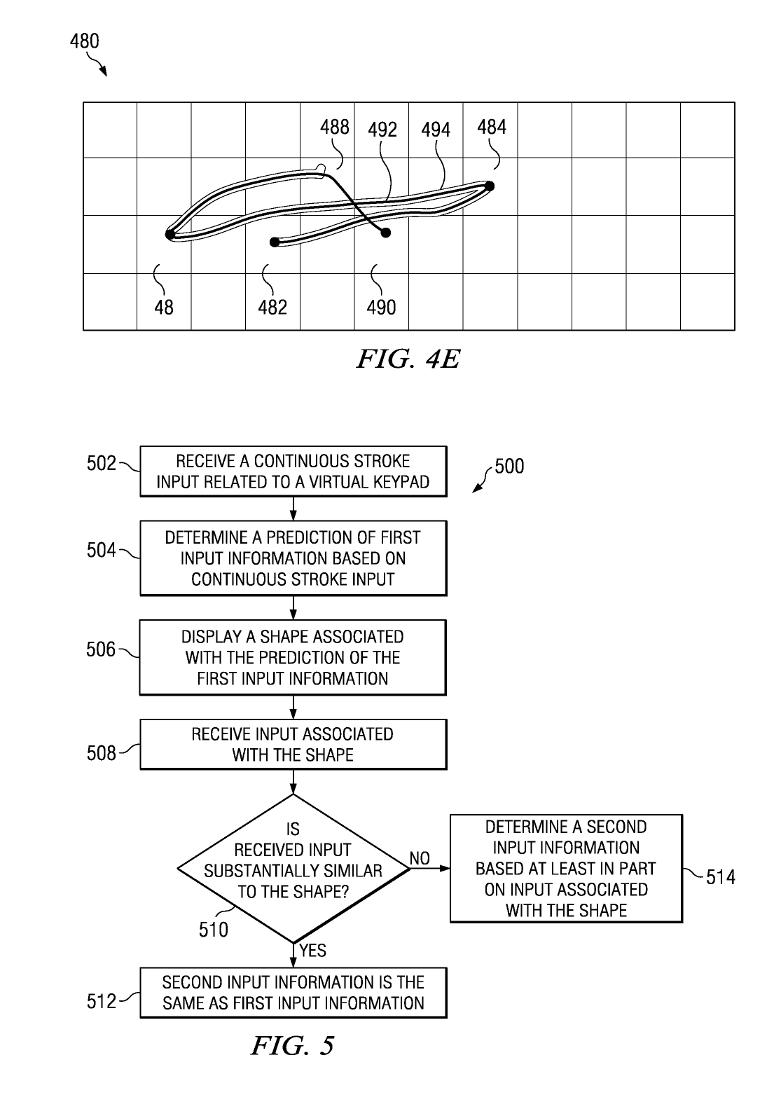

At block 302, the apparatus receives a continuous stroke input for example continuous stroke input 418 of FIG. 4A, related to a virtual keypad. The reception, the continuous stroke input, and the virtual keypad are similar as described with reference to block 102 of FIG. 1.

At block 304, the apparatus determines a first input information based, at least in part, on the continuous stroke input. The determination is similar as described with reference to block 104 of FIG. 1.

At block 306, the apparatus displays a shape associated with the first input information. In an example embodiment, the shape comprises a representation of the continuous stroke input. For example, the shape may represent information related to position, time, speed, and or the like as received for the continuous stroke input. In such an example, the shape may be a rendering of the continuous stroke input. The shape may indicate virtual keys associated with the first input information. For example, the shape may comprise a dot, bullet, indicator, and/or the like, associated with a virtual key included in the first input information.

In another example embodiment, the shape comprises a generated shape based on the first input information. For example, the apparatus may not possess adequate information to recreate the received continuous stroke information. In such an example, the apparatus may utilize dictionary information, curve fitting, extrapolation, and/or the like to generate a shape that, if received as a continuous stroke input, would yield the first input information. For example, if the first input information comprises predicted input information, the shape may represent a predicted path. In another example, the apparatus does not store continuous stroke input after determining first input information. In such an example, the apparatus generates the shape.

At block 308, the apparatus receives input associated with the shape. In an example embodiment, the input associated with the shape relates to extending a non-terminated continuous stroke input that is substantially similar to the shape. For example, the extended continuous stroke input may be substantially similar in that the determined input information of the shape and the continuous stroke input are the same. In another example embodiment, the input associated with the shape relates to extending a non-terminated continuous stroke input that is substantially different from the shape. For example, the first input information may comprise inaccurate predicted input information and/or the shape may comprise an inaccurate predicted shape.

In another example embodiment, the input associated with the shape comprises modification of the shape. For example, the input associated with the shape relates to including and additional virtual key, excluding a previously included virtual key, and/or the like. In such an example, the input associated with the shape relates to dragging at least part of the shape to include and/or exclude a virtual key.

At block 310, the apparatus determines a second input information based at least in part on input associated with the shape. The determination of the second input information is similar as described with reference to block 204 of FIG. 2, where the input associated with the shape is at least a partial basis for the determination.

FIGS. 4A-4E are diagrams illustrating input associated with a displayed shape according to an example embodiment of the invention. Although the examples of FIGS. 4A-4E show a virtual keypad, it should be understood that an apparatus may or may not display the virtual keypad. For example, an apparatus may provide an area for receiving continuous stroke input, but may forego display of the virtual keypad, for example, if a user desires to avoid displaying the virtual keypad.

FIG. 4A is a diagram illustrating an example 400 of input associated with a displayed shape. In an example embodiment, virtual key 402 relates to an “E” character, virtual key 404 relates to an “N” character, virtual key 406 relates to a “T” character, virtual key 408 relates to an “O” character, virtual key 410 relates to an “M” character, virtual key 412 relates to an “L” character, virtual key 414 relates to a “G” character, and virtual key 416 relates to a “Y” character. In example 400, continuous stroke input 418 indicates characters “ENTOMOLOG”. An apparatus may determine input information “ENTOMOLOGY”, for example by performing block 304 of FIG. 3. Shape 419 represents a shape comprising a predicted path of continuous stroke input 418. The predicted path of shape 419 represents a path from virtual key 414 to virtual key 416.

FIG. 4B is a diagram illustrating an example 420 of input associated with a displayed shape. As in example 400, virtual key 402 relates to an “E” character, virtual key 404 relates to an “N” character, virtual key 406 relates to a “T” character, virtual key 408 relates to an “O” character, virtual key 410 relates to an “M” character, virtual key 412 relates to an “L” character, virtual key 414 relates to a “G” character, and virtual key 416 relates to a “Y” character. In example 420, shape 419 represents a shape of determined input information “ENTOMOLOGY” determined when continuous stroke input 421 was near to or intersecting with virtual key 414, similar to continuous stroke input 418 of FIG. 4A. It can be seen that even though continuous stroke input 421 differs from shape 419 between virtual key 414 and virtual key 416, an apparatus may determine that continuous stroke input 421 is substantially similar to shape 419 in that continuous stroke input 421 comprises a path between virtual keys 414 and 416.

FIG. 4C is a diagram illustrating an example 440 of input associated with a displayed shape. In an example embodiment, virtual key 442 relates to an “E” character, virtual key 444 relates to an “N” character, virtual key 446 relates to a “T” character, virtual key 448 relates to an “O” character, virtual key 450 relates to an “M” character, virtual key 452 relates to an “L” character, virtual key 454 relates to a “G” character, and virtual key 456 relates to a “Y” character. In example 440, shape 458 represents a shape of determined input information “ENTOMOLOGY” with information indicating the input information in relation to the virtual keypad. For example, shape 458 comprises points indicating that the input information comprises virtual key 442, virtual key 444, virtual key 446, 3 instances of virtual key 448, virtual key 450, virtual key 452, virtual key 454, and virtual key 456.

FIG. 4D is a diagram illustrating an example 460 of input associated with a displayed shape. In an example embodiment, virtual key 462 relates to an “F” character, virtual key 464 relates to an “I” character, virtual key 466 relates to an “S” character, virtual key 468 relates to a “T” character, and virtual key 470 relates to an “R” character. In example 460, shape 472 represents a shape of input information “FIST” with information indicating the input information in relation to the virtual keypad. In example 460, shape 474 represents a shape resulting from input associated with shape 472. For example, the input associated with shape 472 may comprise tapping virtual key 470, dragging a part of shape 472 to virtual key 470, and/or the like. In example 460, an apparatus may determine input information associated with shape 474 to be “FIRST”.

FIG. 4E is a diagram illustrating an example 480 of input associated with a displayed shape. In an example embodiment, virtual key 482 relates to an “F” character, virtual key 484 relates to an “I” character, virtual key 486 relates to an “S” character, virtual key 488 relates to a “T” character, and virtual key 490 relates to an “H” character. In example 480, shape 492 represents a shape of input information “FIST” with information indicating the input information in relation to the virtual keypad. In example 480, shape 494 represents a shape resulting from input associated with shape 472. For example, the input associated with shape 492 may comprise tapping virtual key 490, dragging a part of shape 492 to virtual key 490, dragging the information indicating virtual key 488 of shape 492 to virtual key 490, and/or the like. In example 480, an apparatus may determine input information associated with shape 494 to be “FISH”.

It should be understood that the corrections discussed in this document are merely examples of corrections that a user may perform. For example a user may change the order of letters in a word, case of letters in a word, change a single word into two words, and/or the like. The apparatus may allow the user to modify the shape associated with the input information by adding to the beginning and/or end of the continuous stroke input to include one or more additional virtual keys. For example, the user may modify the shape associated with the word “MATURE” so that the shape relates to input information of “PREMATURE”. In such circumstances, the user may modify the shape to reflect the desired changes.

In an example embodiment, the apparatus may indicate possible modifications to a user when the user is modifying a shape. For example, if a user is modifying the shape associated with the word “MIKE”, the apparatus may highlight the virtual keys associated with the letters L, C, and/or the like, when the user is modifying the shape to remove inclusion of the virtual key associated with the letter K. For example, as the part of the shape associated with the K virtual key is moved, the apparatus may highlight the virtual keys associated with the letters L, C, and/or the like.

FIG. 5 is a flow diagram showing yet another method 500 for determining input information associated with a continuous stroke input according to an example embodiment of the invention. An apparatus, for example electronic device 10 of FIG. 10, may utilize method 500.

At block 502, the apparatus receives a continuous stroke input related to a virtual keypad. The reception, the continuous stroke input, and the virtual keypad are similar as described with reference to block 102 of FIG. 1.

At block 504, the apparatus determines a prediction of first input information based, at least in part, on the continuous stroke input. The determination is similar as described with reference to block 104 of FIG. 1, where the apparatus performs determination during a continuous stroke input.

At block 506, the apparatus displays a shape associated with the prediction of the first input information. The displaying of the shape is similar as described with reference to block 306 of FIG. 3. For example, the displaying of a shape may relate to a shape such as shape 419 of FIGS. 4A and 4B, shape 458 of FIG. 4C, and/or the like.

At block 508, the apparatus receives input associated with the shape. The input associated with the shape may comprise further continuous stroke input, such as shown in continuous stroke input 421 of FIG. 4B. In another example, the input related to the shape may comprise input related to selecting the shape for second input information determination. For example, the input related to the shape may comprise dragging to a selection virtual key, dragging off the screen, and/or the like. In yet another example, the input related to the shape may comprise continuous stroke input substantially different from the shape, for example if the predicted input information is incorrect.

At block 510, the apparatus determines if the received input associated with the shape is substantially similar to the shape. For example, the apparatus may determine that continuous stroke input 421 and shape 419 of FIG. 4B are substantially similar. Conversely, the apparatus may determine that the continuous stroke input is substantially different in that it may relate to input information different from the first input information.

If, at block 510, the apparatus determines that the received input associated with the shape is substantially similar to the shape, the apparatus determines the second input information to be the same as the first input information at block 512.

If, at block 510, the apparatus determines that the received input associated with the shape is substantially different from the shape, the apparatus determines a second input information based, at least in part, on input associated with the shape at block 514. The determination is similar as described with reference to block 104 of FIG. 1.

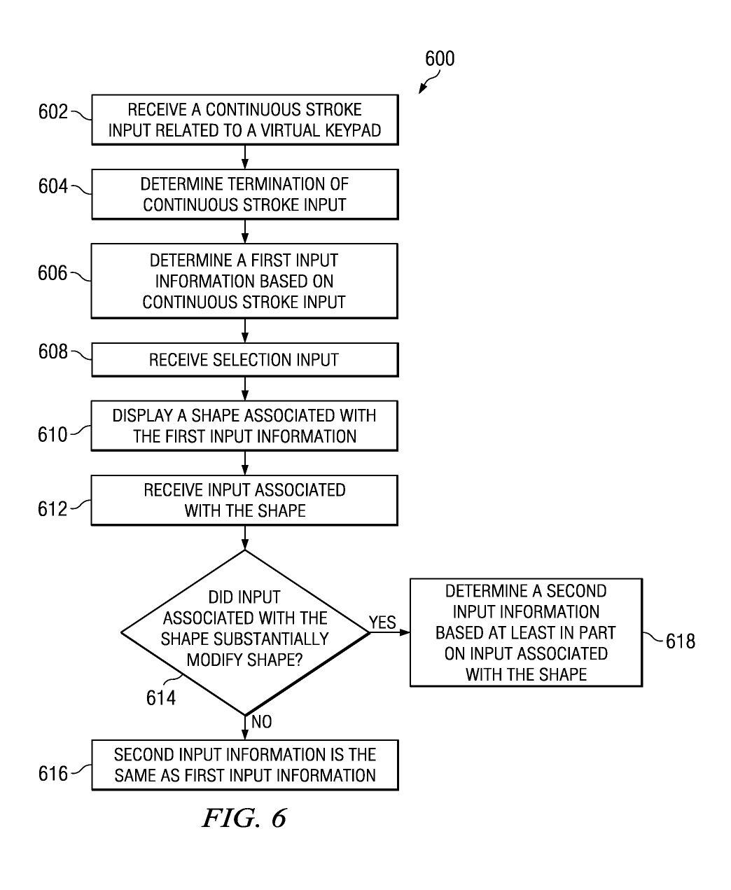

FIG. 6 is a flow diagram showing still another method 600 for determining input information associated with a continuous stroke input according to an example embodiment of the invention. An apparatus, for example electronic device 10 of FIG. 10, may utilize method 600.

At block 602, the apparatus receives a continuous stroke input related to a virtual keypad. The reception, continuous stroke input, and virtual keypad are similar as described with reference to block 102 of FIG. 1.

At block 604, the apparatus determines that the continuous stroke input has terminated. For example, the continuous stroke input may be terminated by a release input, such as release input 946 of FIG. 9C, a release during moving, similar as described with reference to input 960 of FIG. 9D, and/or the like.

At block 606, the apparatus determines a first input information based, at least in part, on the continuous stroke input. The determination is similar as described with reference to block 104 of FIG. 1.

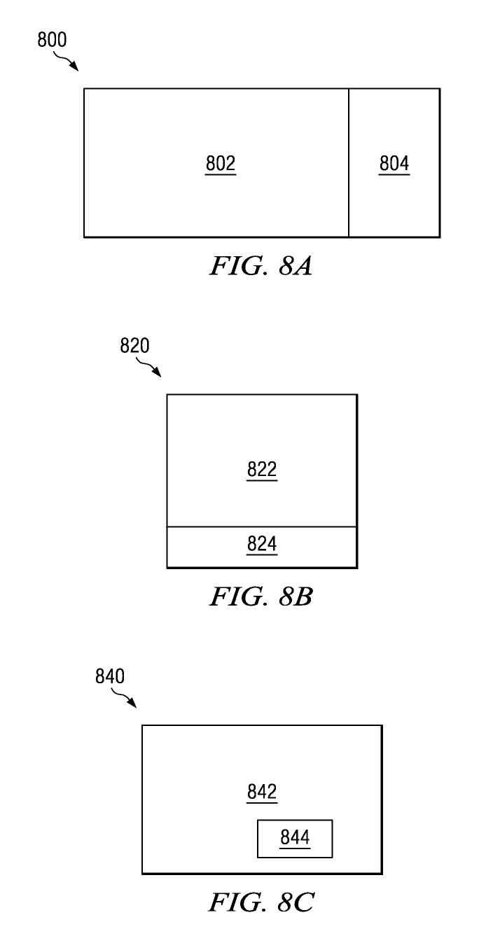

At block 608, the apparatus receives a selection input. In an example embodiment, the selection input may relate to selecting a representation of input information. For example, a word may be displayed in a frame of a text editing program, for example frame 822 of FIG. 8B. In such an example, the selection input may relate to tapping the word, such as input 900 of FIG. 9A, dragging across the word, such as input 920 of FIG. 9B, swiping across the word, such as input 960 of FIG. 9D, and/or the like.

At block 610, the apparatus displays a shape associated with the first input information. The displaying of the shape is similar as described with reference to block 306 of FIG. 3. For example, the displaying of a shape may relate to a shape such as shape 458 of FIG. 4C, shape 472 of FIG. 4D, shape 492 of FIG. 4E, and/or the like.

At block 612, the apparatus receives input associated with the shape. The input associated with the shape may comprise a tap input, such as input 900 of FIG. 9A, a drag input, such as input 920 of FIG. 9B, a swipe input, such as input 960 of FIG. 9D, and/or the like. The input associated with the shape may relate to including an additional virtual key, excluding a previously included virtual key, replacing an included virtual key with a different virtual key, and/or the like. For example, the input associated with the shape may relate to modifying the shape, such as input to modify shape 472 to shape 474 of FIG. 4D, input to modify shape 492 to shape 494 of FIG. 4E, and/or the like.

At block 614, the apparatus determines if the received input associated with the shape substantially modifies the shape. For example, the apparatus may determine that input resulting in shape 474 is a substantial modification to shape 472 of FIG. 4D. Conversely, the apparatus may determine that the received input associated with the shape does not substantially modify the shape in that the shape resulting from the input may relate to the same input information as the shape displayed at block 610.

If, at block 614, the apparatus determines that the received input associated with the shape did not substantially modify the shape, at block 616 the apparatus determines the second input information to be the same as the first input information.

If, at block 614, the apparatus determines that the received input associated with the shape did substantially modify the shape, at block 618 the apparatus determines a second input information based, at least in part, on input associated with the shape. The determination is similar as described with reference to block 104 of FIG. 1.

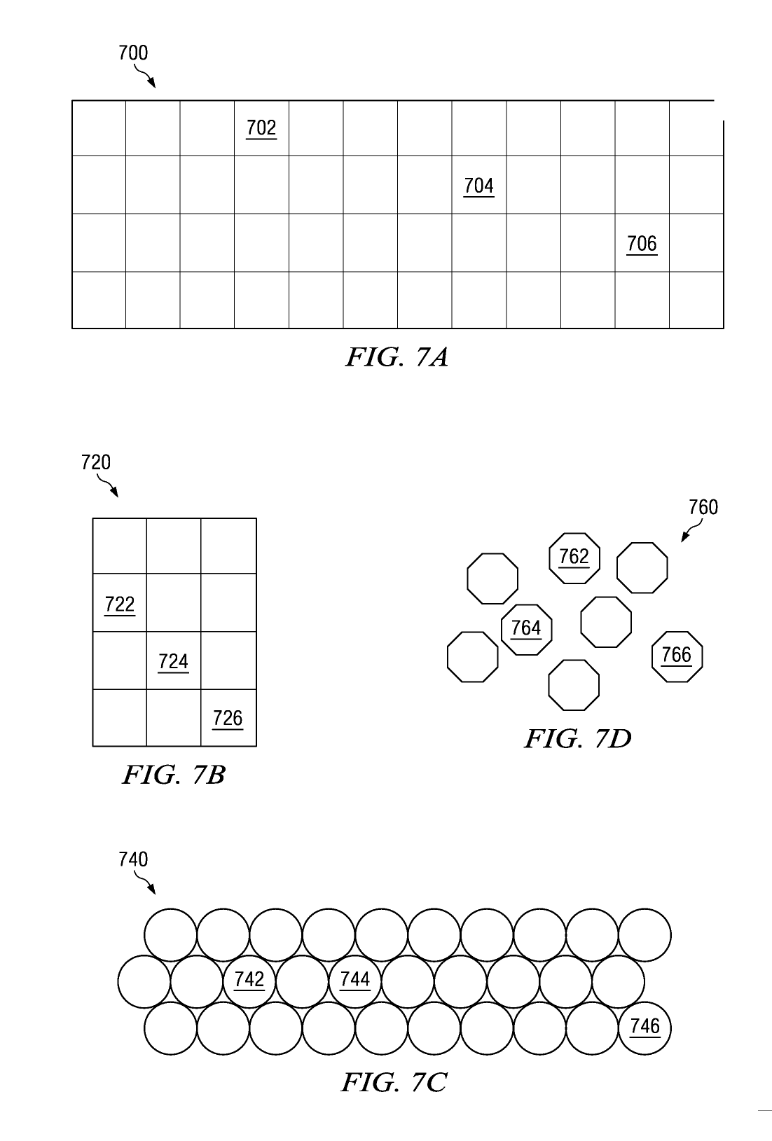

FIGS. 7A-7D are diagrams illustrating a visual representation of a virtual keypad according to an example embodiment of the invention. In an example embodiment, a virtual keypad is a representation of one or more virtual keys. A virtual key may relate to a character, such as a number, letter, symbol, and/or the like, a control, such as shift, alt, command, function, and/or the like, or something similar. The position of touch display input in relation to position of one or more virtual keys may influence input information associated with the touch display input. For example, a tap input, such as tap input 900 of FIG. 9A, a touch display input at a position associated with a virtual key for a “Z” character may provide input information associated with the “Z” character. In such an example, the touch display input may cause, at least in part, a frame, for example frame 802 of FIG. 8, to display the “Z” character. The number, shape, position, and/or the like, of virtual keys within a virtual keypad may vary. For example, one virtual keypad may have 17 round adjacent virtual keys, while a different virtual keypad may have 50 rectangular non-adjacent virtual keys. The size of virtual keys may vary. For example, one virtual key of a virtual keypad may be larger than a different virtual key of the same virtual keypad.

FIG. 7A illustrates a virtual keypad 700 according to an example embodiment of the invention. In the example embodiment, virtual keypad 700 comprises 48 adjacent square virtual keys. In an example embodiment, virtual keys 702, 704, and 706 relate to characters and/or controls. For example, virtual key 702 may relate to a “4” character, virtual key 704 may relate to an “I” character, and virtual key 706 may relate to an “Enter” control.

FIG. 7B illustrates a virtual keypad 720 according to an example embodiment of the invention. In the example embodiment, virtual keypad 720 comprises 12 adjacent square virtual keys. In an example embodiment, virtual keys 722, 724, and 726 relate to characters and/or controls. For example, virtual key 722 may relate to a “4” character, virtual key 724 may relate to an “8” character, and virtual key 726 may relate to a “#” character.

FIG. 7C illustrates a virtual keypad 740 according to an example embodiment of the invention. In the example embodiment, virtual keypad 740 comprises 30 adjacent circular virtual keys. In an example embodiment, virtual keys 742, 744, and 746 relate to characters and/or controls. For example, virtual key 742 may relate to a “D” character, virtual key 744 may relate to a “G” character, and virtual key 746 may relate to a “?” character.

FIG. 7D illustrates a virtual keypad 760 according to an example embodiment of the invention. In the example embodiment, virtual keypad 760 comprises 8 non-adjacent unevenly distributed octagonal virtual keys. In an example embodiment, virtual keys 762, 764, and 766 relate to characters and/or controls. For example, virtual key 762 may relate to a “+” character, virtual key 764 may relate to a “$” character, and virtual key 746 may relate to a “*” character.

FIGS. 8A-8C are diagrams illustrating display position of a virtual keypad, for example virtual keypad 700 of FIG. 7A, according to an example embodiment of the invention.

In the example embodiment 800 of FIG. 8A, the position of virtual keypad 804 is to the side of frame 802. Frame 802 may comprise information associated with a software program. For example, frame 802 may show text associated with a text program, web-page information associated with a browser program, and/or the like. In an example embodiment, information displayed in frame 802 relates to input associated with virtual keypad. For example, frame 802 may display a word entered using virtual keypad 804. The position of virtual keypad 804 may be to the left of frame 802, or to the right of frame 802. In addition, the height of virtual keypad may be the same as frame 802 or different from frame 802. Furthermore, frame 802 may comprise one or more additional frames. For example, frame 802 may comprise a frame for displaying document information and a frame for displaying file folder information.

In the example embodiment 820 of FIG. 8B, the position of virtual keypad 824 is below frame 822. Frame 822 may comprise information associated with a software program. For example, frame 822 may show text associated with a text program, web-page information associated with a browser program, and/or the like. In an example embodiment, information displayed in frame 822 relates to input associated with virtual keypad. For example, frame 822 may display a word entered using virtual keypad 824. The position of virtual keypad 824 may be below frame 822, or above frame 822. In addition, the width of virtual keypad may be the same as frame 822 or different from frame 822. Furthermore, frame 822 may comprise one or more additional frames. For example, frame 822 may comprise a frame for displaying browser information and a frame for displaying address information.

In the example embodiment 840 of FIG. 8C, the position of virtual keypad 844 is within frame 842. Frame 842 may comprise information associated with a software program. For example, frame 842 may show text associated with a text program, web-page information associated with a browser program, and/or the like. In an example embodiment, information displayed in frame 842 relates to input associated with virtual keypad. For example, frame 842 may display a word entered using virtual keypad 844. The width of virtual keypad may be the same as frame 842 or different from frame 842. Furthermore, frame 842 may comprise one or more additional frames. For example, frame 842 may comprise a frame for displaying drawing information and a frame for displaying label information.

FIGS. 9A-9D are diagrams illustrating input from a touch display, for example from display 28 of FIG. 10, according to an example embodiment of the invention. In FIGS. 9A-9D, a circle represents an input related to contact with a touch display, two crossed lines represent an input related to releasing a contact from a touch display, and a line represents input related to movement on a touch display.

In the example of FIG. 9A, input 900 relates to receiving contact input 902 and receiving a release input 904. In this example, contact input 902 and release input 904 occur at the same position. In an example embodiment, an apparatus utilizes the time between receiving contact input 902 and release input 904. For example, the apparatus may interpret input 900 of FIG. 9A as a tap for a short time between contact input 902 and release input 904, as a press for less short time between contact input 902 and release input 904, and/or the like. In such an example, a tap input may induce one operation, such as selecting an item, and a press input may induce another operation, such as performing an operation on an item.

In the example of FIG. 9B, input 920 relates to receiving contact input 922, a movement input 924, and a release input 926. In this example, contact input 922 and release input 926 occur at different positions. Input 920 may relate to dragging an object from one position to another, to moving a scroll bar, to panning a virtual screen, to drawing a shape, and/or the like. In an example embodiment, an apparatus interprets input 920 of FIG. 9B differently based at least in part on the speed of movement 924. For example, if input 920 relates to panning a virtual screen, the panning motion may be small for a slow movement, large for a fast movement, and/or the like.

In the example of FIG. 9C, input 940 relates to receiving contact input 942, a movement input 944, and a release input 946 are shown. In this example, contact input 942 and release input 946 occur at different positions. Input 940 may relate to dragging an object from one position to another, to moving a scroll bar, to panning a virtual screen, to drawing a shape, and/or the like. In an example embodiment, an apparatus interprets input 940 of FIG. 9C differently based at least in part on the speed of movement 944. For example, if input 940 relates to panning a virtual screen, the panning motion may be small for a slow movement, large for a fast movement, and/or the like.

In the example of FIG. 9D, input 960 relates to receiving contact input 962, and a movement input 964, where contact is released during movement. Input 960 may relate to dragging an object from one position to another, to moving a scroll bar, to panning a virtual screen, to drawing a shape, and/or the like. In an example embodiment, an apparatus interprets input 960 of FIG. 9D differently based at least in part on the speed of movement 964. For example, if input 960 relates to panning a virtual screen, the panning motion may be small for a slow movement, large for a fast movement, and/or the like.

In the example of FIG. 9E, input 980 relates to receiving contact inputs 982 and 988, movement inputs 984 and 990, and release inputs 986 and 992. In this example, contact input 982 and 988, and release input 986 and 992 occur at different positions. Input 980 may relate to dragging an object from one position to another, to moving a scroll bar, to panning a virtual screen, to drawing a shape, and/or the like. In an example embodiment, an apparatus interprets input 980 differently based at least in part on the speed of movements 984 and 990. For example, if input 980 relates to zooming a virtual screen, the zooming motion may be small for a slow movement, large for a fast movement, and/or the like.

FIG. 10 is a block diagram showing an electronic device 10 according to an example embodiment of the invention. It should be understood, however, that an electronic device as illustrated and hereinafter described is merely illustrative of an electronic device that would benefit from embodiments of the present invention and, therefore, should not be taken to limit the scope of the present invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, global positioning system (GPS) devices and other types of electronic systems, may readily employ embodiments of the present invention. Furthermore, devices may readily employ embodiments of the present invention regardless of their intent to provide mobility.

Even though embodiments of the present invention are described in conjunction with mobile communications applications, it should be understood that embodiments of the present invention may be utilized in conjunction with a variety of other applications, both in the mobile communications industries and outside of the mobile communications industries.

The electronic device 10 comprises an antenna 12 (or multiple antennae) in operable communication with a transmitter 14 and a receiver 16. The electronic device 10 further comprises a controller 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, wireless networking protocols, such as 802.11, short-range wireless protocols, such as Bluetooth, and/or the like.

Controller 20 may comprise circuitry for implementing audio, video, communication, navigation, logic functions, and or the like. For example, controller 20 may comprise a digital signal processor device, a microprocessor device, various analog to digital converters, digital to analog converters, and other support circuits. The apparatus may perform control and signal processing functions of the electronic device 10 among these devices according to their respective capabilities. The controller 20 thus may comprise the functionality to encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the controller 20. The user input interface, which allows the electronic device 10 to receive data, may comprise one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display may determine input based on position, motion, speed, contact area, and/or the like. In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 comprises hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the controller 20 in the form of software for creating a digital image file from a captured image. In an example embodiment, the camera module 36 may further comprise a processing element such as a co-processor that assists the controller 20 in processing image data and an encoder and/or decoder for compressing and/or decompressing image data. The encoder and/or decoder may encode and/or decode according to a standard format, for example, a JPEG standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may additionally or alternatively comprise an EEPROM, flash memory or the like. The memories may store any of a number of pieces of information, and data. The information and data may be used by the electronic device 10 to implement on or more functions of the electronic device 10. For example, the memories may comprise an identifier, such as an international mobile equipment identification (IMEI) code, which may uniquely identify the electronic device 10.

Although FIG. 10 illustrates an example of an electronic device that may utilize embodiments of the present invention, it should be understood that the electronic device 10 of FIG. 10 is merely an example device that may utilize embodiments of the present invention.

Without in any way limiting the scope, interpretation, or application of the claims appearing below, a technical effect of one or more of the example embodiments disclosed herein may be simplifying continuous stroke input for a virtual keypad. Another technical effect of one or more of the example embodiments disclosed herein may be simplifying editing using a virtual keypad. Still another technical effect of one or more of the example embodiments disclosed herein may be reducing the number of times a user releases a screen contact when performing input. Yet another technical effect of one or more of the example embodiments disclosed herein may be assisting the user's determination of which virtual keys to include in a continuous stroke input.

Embodiments of the present invention may be implemented in software, hardware, application logic or a combination of software, hardware and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined. For example, block 608 may be omitted from method 600.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-39. (canceled)

40. An apparatus, comprising a processor configured to:
receive a continuous stroke input related to a virtual keypad;
determine a first input information based at least in part on said continuous stroke input;
display a shape associated with said first input information;
receive input associated with said shape; and
determine a second input information based at least in part on said shape and said input associated with said shape.

41. The apparatus according to claim 40, wherein said shape comprises information indicating said first input information in relation to said virtual keypad.

42. The apparatus according to claim 40, wherein said first input information comprises predicted input information based at least in part on said continuous stroke input.

43. The apparatus according to claim 40, wherein said shape comprises a predicted path of said continuous stroke input.

44. The apparatus according to claim 43, wherein said input associated with said shape comprises continuous stroke input substantially similar to said shape.

45. The apparatus according to claim 44, wherein said second input information is the same as said first input information.

46. The apparatus according to claim 43, wherein said input associated with said shape comprises continuous stroke input substantially different from said shape.

47. The apparatus according to claim 40, wherein said processor is further configured to determine termination of said continuous stroke input.

48. The apparatus according to claim 47, wherein said processor is further configured to receive a selection input associated with a representation of said first input information.

49. The apparatus according to claim 47, wherein said input associated with said shape comprises substantially modifying said shape.

50. The apparatus according to claim 49, wherein said second input information is different than said first input information.

51. The apparatus according to claim 49, wherein said modification comprises modifying said shape to include an additional virtual key.

52. The apparatus according to claim 51, wherein said modification comprises selecting a position on said shape.

53. The apparatus according to claim 51, wherein said modification comprises moving at least part of said shape.

54. The apparatus according to claim 49, wherein said modification comprises modifying said shape to exclude a previously included virtual key.

55. The apparatus according to claim 54, wherein said modification comprises moving at least part of said shape associated with said virtual key.

56. The apparatus according to claim 54, wherein said modification comprises removing an indication of inclusion of said virtual key.

57. The apparatus according to claim 40, wherein the processor comprises at least one memory that contains executable instructions that when executed by the processor cause the apparatus to:
receive a continuous stroke input related to a virtual keypad;
determine a first input information based at least in part on said continuous stroke input;
display a shape associated with said first input information;
receive input associated with said shape; and
determine a second input information based at least in part on said shape and said input associated with said shape.

58. A method, comprising:
receiving a continuous stroke input related to a virtual keypad;
determining a first input information based at least in part on said continuous stroke input;
displaying a shape associated with said first input information;
receiving input associated with said shape; and
determining a second input information based at least in part on said shape and said input associated with said shape.

59. A computer program product comprising a computer-readable medium bearing computer program code embodied therein for use with a computer, the computer program code comprising:
code for receiving a continuous stroke input related to a virtual keypad;
code for determining a first input information based at least in part on said continuous stroke input;
code for displaying a shape associated with said first input information;
code for receiving input associated with said shape; and
code for determining a second input information based at least in part on said shape and said input associated with said shape.
